(19) United States
(12) Patent Application Publication
(10) Pub. No.: US 2003/0187665 A1
(43) Pub. Date: Oct. 2, 2003

(54) Method of distributing and selling high end products

(76) Inventor: Dennis Boyd, Chesterfield, MO (US)

Correspondence Address: David R. Deal, Thompson Coburn LLP, Suite 3500, One US Bank Plaza, St. Louis, MO, 63101-9928, US

(21) Appl. No.: 10/107,870

(22) Filed: Mar. 27, 2002

(51) Int. Cl. G06F 17/60

(52) U.S. Cl. 705/1

(57) ABSTRACT

An improved method of distributing products to stores of a members-only chain includes using a vendor to provide for approval and physical distribution of products sequentially to stores of the chain and local retailers in each market of the chain for providing sales, storage and delivery services for products sold in the chains members-only stores.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

This invention relates generally to selling in members-only stores and more particularly to programs for selling in such stores using available resources in a new and more efficient manner.

Various members-only store chains are known. For example, Sam's Wholesale Clubs are found throughout the country and offer products at significant discounts to their members. Other such chains are Costco and BJ's. Only members are allowed to purchase products at such stores. To provide variety of product offering for their members, members-only chains frequently offer special items for a limited amount of time in each store. For example, Sam's Wholesale Clubs rotate such products into individual stores for a period of approximately twenty days and prohibit display of the same special products more than twice per year per store. Such a program of rotating merchandise through the stores can be used by members-only chains not only to provide variety, but also to determine if particular products are well-enough received to add to the permanent line of products for that chain and/or store.

One way that members-only chains provide variety in the product offering is what is called a “road show”. In a conventional road show, a group of products is moved from store to store across the country. Typically, sales people at the local store are used to explain and sell the products, or sales people are moved from store to store across the country with the show. A problem with the first approach is that the local store may or may not have sales people trained to sell products of the kind displayed in the road show. Even if one local store does have such trained sales people, there is no guarantee that the next store on the road show will, or the store after that. This problem is particularly acute when the products in the road show are products such as furniture, rugs and high-end art that generally require human interaction in connection with the sale. Such products require some explanation of their features and are generally sold by trained sales people.

Moving sales people from store to store with the road show solves the first problem, but leads to others. For example, moving sales people from store to store across the country necessarily involves travel expense and the expense of feeding and housing the sales people at each location. Moreover, sales people moved from store to store around the country with a traditional road show quickly burn out, requiring the hiring and/or training of new sales people frequently.

Even if the sales person problem is solved, there remain other problems with road shows. For example, there are unique logistics problems associated with many road show products. For example, furniture typically must be delivered to the home of the purchaser and, in many cases, set up. This requires delivery, which many members-only stores are not routinely equipped to provide. Large goods such as furniture must also be stored pending sale. But members-only stores are often not equipped to handle the storage of these “special” items in the quantities required to make the road show a success. Such goods could be stored in containers on the parking lot of the members-only store. But such containers are not environmentally controlled, so damage to the products could easily result.

Road shows suffer from other problems. Product that may be suitable for one area of the country may not be optimal for another area. Using an example from the furniture area, houses in the northeastern part of the United States are on average smaller than in other parts of the country. As a result queen size beds are relatively more popular than king size beds in the Northeast. Moreover, narrower and taller case pieces are preferred in the Northeast to accommodate the smaller bedroom sizes and narrow staircases. Conventional road shows ignore these regional differences, and in any event have no organized method for taking them into account. Moreover, regional differences can also impact the sales person/customer interaction when the sales people move with the show. For example, with a traveling sales person, a New York sales woman could easily be attempting to sell product to an Alabama customer. This situation raises unnecessary barriers to a sale.

Traditional road shows also suffer from other logistical problems. For example, maximum cost efficiency is achieved in connection with these shows if large containers of products are received at the local members-only store only shortly before the opening of the road show at that store. But what if shipment is delayed? And who has the knowledge to accurately forecast the volume of product that will be needed at any particular stop on the road show? These problems seem to be insoluble for traditional road shows.

Because of the various problems inherent in traditional road shows, the profit margins achieved from the shows are lower than desired. These relatively low margins tend to force the road shows to attempt to reduce commissions, resulting in even higher turnover of sales people.

Some members-only chains have a road show coordinator, but that person cannot be expected to solve all the problems inherent in a road show. For example, forecasting the requirements of products (which products by definition are unique for the chain) for any particular store along the road show can be a daunting task. Moreover, the chain road show coordinator can become aware of shipment delays, but typically lacks the tools necessary to compensate for those delays. And, a single road show coordinator, no matter how talented, cannot be expected to have expertise concerning the variety of products to be offered in the various road shows used by that chain in a single year.

Conventional road shows, therefore, have significant disadvantages and associated increased expenses that make the shows less successful than they might otherwise be.

### SUMMARY OF THE INVENTION

Among the various objects and features of the present invention are the provision of an improved method for conducting road show for members-only chains.

Another object is the provision of such a method that overcomes the hurdles involved in selling product for a limited amount of time in a single store.

A third object is the provision of such a method that allows chains to intelligently evaluate road show products for inclusion in its permanent line of products.

A fourth object is the provision of such a method using experienced, local sales people, while significantly reducing the problem of burnout.

A fifth object is the provision of such a method that is particularly suitable for products requiring human interaction in connection with the sale of products and/or logistical support during the road show.

A sixth object is the provision of such a method that has reduced cost and expense.

A seventh object is the provision of such a method that provides environmentally controlled storage facilities for road show product at minimal marginal expense.

An eighth object is the provision of such a method that takes into account regional differences in the desired selection of products to be sold in the road show.

A ninth object is the provision of such a method that handles logistics in an improved fashion.

A tenth object is the provision of such a method with improved forecasting.

Different embodiments of the invention may involve one or more of the objects and features mentioned above. Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 is a schematic diagram illustrating various relationships among the entities performing the present method.

FIG. 2 is a block diagram illustrating one possible set of products particularly adapted for sale using the present invention;

FIG. 3 is a block diagram illustrating a second possible set of products particularly adapted for sale using the present invention;

FIG. 4 is a block diagram illustrating a third possible set of products particularly adapted for sale using the present invention; and

FIG. 5 is a block diagram illustrating a fourth possible set of products particularly adapted for sale using the present invention.

### DETAILED DESCRIPTION OF THE PREFERRED EMBODIMENTS

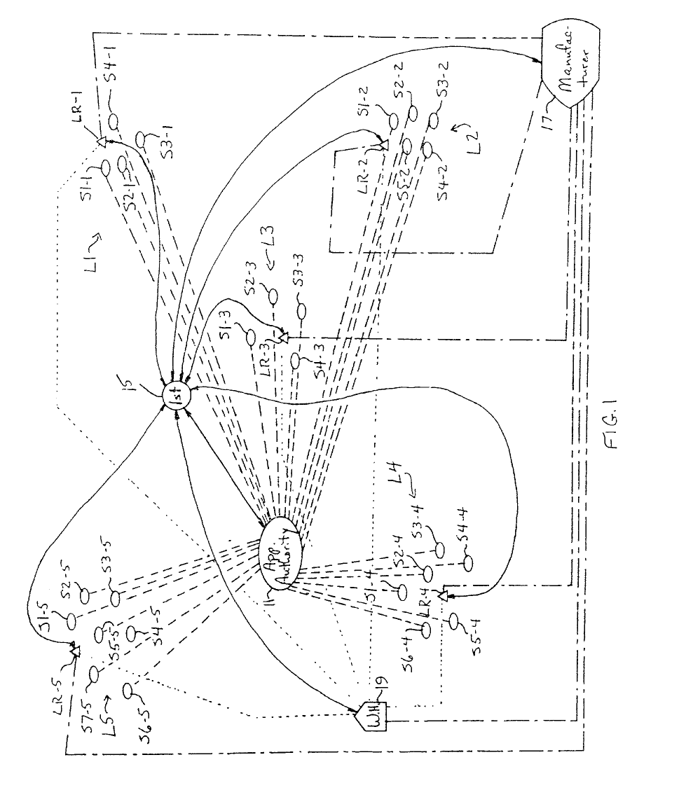

Referring to the accompanying drawings in which like reference numbers indicate like elements, FIG. 1 illustrates in diagrammatic form a chain of members-only stores having stores in five different localities or vicinities labeled L1-L5. For example, locality L1 could be the Boston, Mass. metropolitan area, locality L2 could be the Atlanta, Ga. metropolitan area, locality L3 could be the St. Louis, Mo. metropolitan area, L4 could be the Phoenix, Ariz. metropolitan area, and L5 could be the Seattle, Wash. metropolitan area. FIG. 1 is not to scale. The number of vicinities and individual stores involved with a particular members-only chain could be much larger than the five shown in FIG. 1. For example, Sam's Wholesale Clubs are believed to have over 500 markets nationally in which it has stores. A small number of stores and localities are shown solely for clarity.

Each locality or vicinity has a plurality of stores (although the present method may also be used where a single locality has only a single store). Thus, locality L1 has four stores S1-1 to S4-1 of the chain, locality L2 has five stores S1-2 to S5-2, locality L3 has four stores S1-3 to S4-3, locality L4 has six stores S14 to S64, and locality L5 has seven stores L1-5 to L7-5. It is preferred, for reasons that will appear that a vicinity or locality have stores of the chain that are in a reasonable driving distance, such as seventy miles.

Each of the stores of the chain receive approval from a central product approval authority 11. In the event that the central approval authority is the home office of the chain, the stores also report sales and inventories back to the home office 11. Approval and reporting between the central authority and the stores is indicated by the dashed lines on FIG. 1.

As noted above, a system with a central approval authority 11 and a plurality of stores S around the country is not particularly well-suited for conventional road shows. The present invention overcomes many of the problems inherent in conventional road shows by including in the process a first vendor 15, and local retailers LR-1 to LR-5 in each of the localities L1 to L5. Although only a single local retailer is shown for each locality, the method of the present invention could also use a number of local retailers in each locality as desired. Vendor 15 is in communication with each of the local retailers LR-1 to LR-5 and with the central approval authority 11, all as indicated by solid lines in FIG. 1. Vendor 15 is also in communication with a manufacturer(s) 17, and a central warehousing facility 19. If desired, vendor 15 may also be in direct communication with the various stores S of the chain, or communication may take place between vendor 15 and the stores S through the central office 11.

In this method the vendor 15 undertakes many of the responsibilities that normally fall upon the central office of the chain. In the following example, vendor 15 is responsible for national distribution of furniture (and more particularly bedroom furniture) in the road show format, although the present invention is not limited to the distribution of furniture.

Vendor 15 selects and contracts with local retailers LR in each geographical market in which the members-only chain desires to have a road show. As mentioned above, such chains utilize road shows to enhance its value to its club members by offering non “in line” items at very attractive prices. These products are rotated into each store for a limited time (approx. 20 days) so that the chain can constantly update and refresh its product assortment as a benefit to its club members.

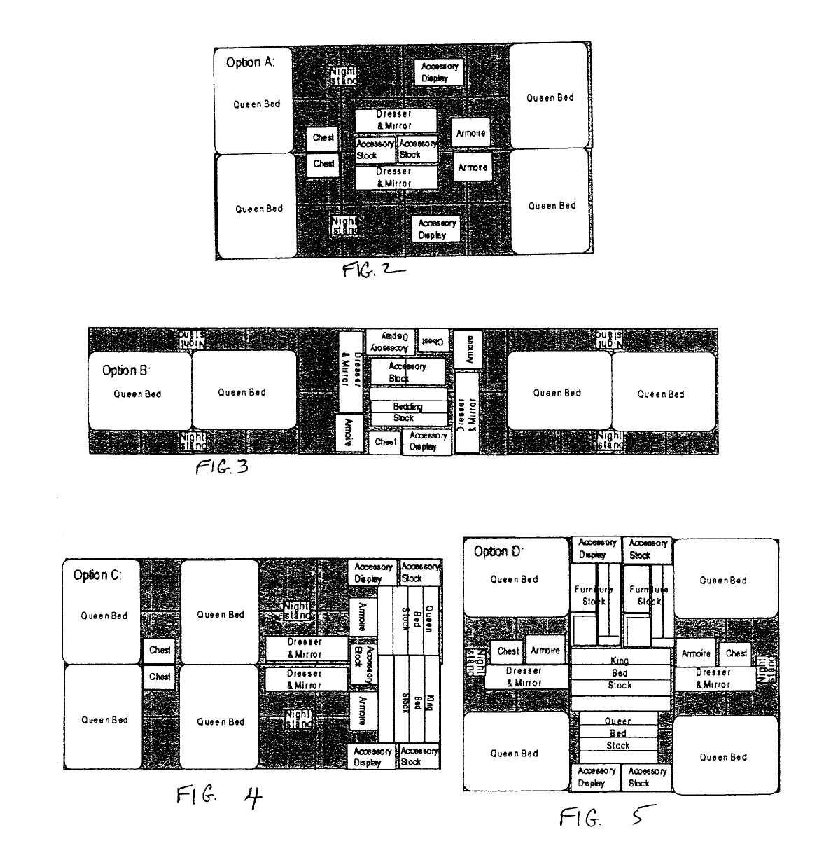

In this example of the present invention, vendor 15 offers four unique road show offerings (shown in FIGS. 2-5) that have been approved by the central product approval authority 11. For example, each road show offering could consist of:

1. Two different bedroom groups with two beds per group (4 total) and full set of matching case goods for each group.

2. Four different specialty sleep mattresses.

3. Accessory racks including latex pillows, memory foam pillows, and massage systems.

Vendor 15 is responsible for obtaining product approval for these offerings from the central product approval authority 11. The central office may then treat the products sold on the road show as a separate store for accounting purposes.

In fact, vendor 15 can be responsible for several steps in the process that are difficult for the stores S or the central office 11 to perform. Similarly, the local retailers LR are not well-suited to perform such tasks. For example, vendor 15 can do the following:

1. Schedule the road show venues with the central office.

2. Set up the sku numbers with the chain.

3. Generate the appropriate UPC codes to selling through the chains point-of-sale system.

4. Provide sales data feedback through the retail link system twice/week for each location (see example).

5. Provide in-store inventory tracking sheets to facilitate stock replenishment.

6. Be responsible for shipping all product to be sold in the road show.

7. Perform pre-show e-mail marketing to those club members in the market area near the next store on the road shows itinerary.

8. Liaison with the chain on any issues, questions or concerns the local retailer has.

9. Reconcile payment weekly between the chain and the local retailer.

The vendor 15 also plans forecasts and replenishes product in combination with the local retailer based upon substantial data from previous sales (either at previous stops of the road show, during previous shows with this local retailer, and/or during previous shows at this members-only store S. Based upon the forecasts, vendor 15 arranges with manufacturer 17 to ship the selected product in the appropriate quantities directly to the local retailer LR for the up-coming road show event. (Excess product can be sold at the next road show.) In is preferred in the present method that product be shipped in container lots from the manufacturer 17. This enables the price to the customer to be set at an extremely attractive level, while still leaving significant profit for the vendor, the chain, and the local retailer. In some cases the manufacturer might be located in a foreign country (such as China), making delivery of the container of product on an accurate schedule difficult. This potential problem is overcome in the present method by making product available from the vendor's central warehouse facility 19 in those cases in which container shipment is otherwise delayed. In one aspect of the invention, the vendor 15 makes the product available from its warehouse at the same price as the direct container lot price to facilitate the operation of the method.

A key to the present invention is the fact that vendor 15 partners with local retailers LR in each market to facilitate, promote and successfully execute the road show so that it will be a profitable experience for the club member, the chain stores S, the vendor 15, and the retailer LR. The local retailer LR is familiar with the product features (and prices) that the local customer will be interested in. The vendor 15 uses this information in determining what products to have shipped to the local retailer LR in a particular market.

The present invention can be very advantageous to the local retailer LR, generating significant profits for no additional fixed costs. The local retailer incurs only the cost of the product and the cost of setting up and taking down the product display at each store S for which it is responsible for the road show. All advertising, rent, utilities and fees are born by the chain and vendor 15. The local retailer LR is responsible for providing at least one and preferably two salespeople to work each show, which are paid a straight commission.

In the example given above, vendor 15 offers multiple sku options, so that it is possible to offer up to four unique shows, twice per year, per store S (8 total shows/year/members-only store). Depending on the number of stores S in the local retailer's market, this gives the local retailer LR the ability to do continuous shows back to back in their marketplace. Ideally, the local retailer LR would have a consistent crew of 2 salespeople to begin a new show every 20 days. One crew of 2 people could do 18 consecutive shows/year (360/20 days=18). Note that this allows maximum use to be made of the salespeople trained to sell the products. Note as well that since a local retailer LR only services road shows occurring in its vicinity (e.g., within seventy miles), the expense of overnight travel is not incurred. Since the salespeople return to their own homes each day, the problem of burnout is also significantly reduced.

The local retailer benefits from this arrangement since otherwise it might not have access to the customers of the members-only chain. Such customers tend to be very loyal and shop regularly at their chain. The local retailer LR would not normally be able to access this customer through their retail store. Moreover, due to the margin structure of the vendor and the chain, as described in more detail below, the pricing offered at the members-only chain store S is much lower than normal retail pricing for these product, which allows the local retailer LR to increase sales volume without a corresponding increase in overhead.

In return for these advantages, the local retailer provides the salespeople, local storage of product to be sold at the members-only store S, and local delivery service for the products sold at store S. The local retailer may also provide any needed service after the sale. Note that the local retailer LR usually has its own warehouse facilities suitable for storing product of the type sold in the road show. For example, environmentally controlled storage is desirable when the products sold in the road show are furniture. Since the local retailer already has this storage, the incremental cost for storing the product in connection with the road show is basically zero. This storage is vastly superior to the alternative of simply storing the product in a container on the parking lot of the members-only store S. Note that most members-only stores have minimal backroom warehousing capability, so that without the storage facilities of the local retailer, additional costs would have to be incurred. Similarly, the local retailer LR already has delivery facilities (vehicles and personnel) for delivering product of this kind to the consumer. Again, the incremental cost of delivery for the local retailer is minimal in this situation.

The present method has superior results when the commission paid to the salespeople exceeds that paid by the local retailer LR at its own retail store. This difference in commission is justified by the fact that rent, utilities, advertising, and other such costs are not incurred by the local retailer LR in connection with the sale of products at the members-only store S. The higher commission (for example, nine or ten per cent) is used to attract superior sales personnel to selling at the road shows. Such salespeople should be congenial, high energy and helpful while still being aggressive enough to ask for the sale. A salesperson that has been successful at home shows or mall sales should do well with these road shows.

The present invention allows the chain to evaluate new products for the market of each store S before adding them to the regular product line. It also allows new products to be considered for inclusion in the road show by taking into account the input of the local retailer LR for each market.

As various modifications could be made in the constructions and methods herein described and illustrated without departing from the scope of the invention, it is intended that all matter contained in the foregoing description or shown in the accompanying drawings shall be interpreted as illustrative rather than limiting.

What is claimed is:

1. A method of distributing and selling products at a chain of members-only stores, said chain having a central product approval authority, said method comprising the steps of:
a first party submitting a request for product approval for a group of products to the central product approval authority, said first party being unaffiliated with the chain;
said central product approval authority approving sale of the group of products in at least some of the stores of the chain;
said first party shipping products of the group to a second party in the vicinity of at least one of the stores of the chain, said second party being unaffiliated with the chain;
said second party warehousing products of the group in warehouse facilities controlled by the second party, said store of the chain having storage facilities associated therewith which are not the warehouse facilities of the second party;
said second party or said first party providing at least one sales person for selling products of the group at said store for a limited period of time;
said store providing display space for products of the group in which said products are displayed and said sales person attempts to make sales;
said store accepting payment for products of the group purchased by members; and
said payment being divided among at least the chain and the second party.

2. The method as set forth in claim 1 further including the step by the chain of evaluating the group of products for inclusion in a continuing line of products carried by the chain.

3. The method as set forth in claim 1 wherein the sales person in attempting to make sales of product of the group to members identifies additional products not included in the group of interest to the members, and in response identifies said additional products to the second party for potential inclusion in displays at other stores in the chain.

4. The method as set forth in claim 1 wherein products purchased by members are delivered by the second party using existing second party delivery vehicles.

5. The method as set forth in claim 1 wherein the warehouse facilities of the second party are environmentally controlled.

6. The method as set forth in claim 1 wherein the warehouse facilities of the second party exceed in size the storage facilities of said store.

7. The method as set forth in claim 1 wherein the products of the group are stored in preexisting warehouse facilities of the second party.

8. The method as set forth in claim 1 wherein the first party stores data on sales of product of said group from said store of the chain, said store being a first store, and from said data generates forecasts of sales of said product at a second store of said chain.

9. The method as set forth in claim 8 wherein the first party ships product of the group to a third party in the vicinity of said second store in amounts corresponding to said forecasts.

10. The method as set forth in claim 9 wherein the amount of said product sold in said first store during the limited period of time is less than the amount of said product shipped by said first party to the second party, so that excess product is disposed in the warehouse facilities of the second party, said first party shipping said excess product to the third party after expiration of the limited period of time.

11. The method as set forth in claim 9 wherein the display of product at the first store of the chain does not overlap the display of product at the second store of the chain.

12. The method as set forth in claim 8 wherein the first and second stores of the chains are in the same vicinity, said first party shipping product of the group to the second party in amounts corresponding to said forecasts.

13. The method as set forth in claim 12 wherein the amount of said product sold in said first store during the limited period of time is less than the amount of said product shipped by said first party to the second party, the amount of product of the group shipped to the second party for the second store taking into account the amount of said product shipped for the first store but not sold in the first store.

14. The method as set forth in claim 12 wherein the display of product at the first store of the chain does not overlap the display of product at the second store of the chain, the second party providing at least one of the same sales persons at the second store as provided at the first store.

15. The method as set forth in claim 1 wherein said chain has a plurality of stores in a vicinity, said method being performed in a predetermined sequence at least several of the stores in the vicinity.

16. The method as set forth in claim 15 wherein the first party generates forecasts for sales of product at said several stores in the vicinity and ships product to the second party at times appropriate for performing the method in the predetermined sequence in said several stores.

17. The method as set forth in claim 15 wherein the second party provides at least some of the same sales people at a plurality of the several stores in the vicinity.

18. The method as set forth in claim 15 wherein the limited period of time in each store of said several stores is such that the second party's sales people may work substantially full time in sales activities at said several stores of the chain in said vicinity.

19. The method as set forth in claim 15 wherein said several stores of the chain fall within a circle having a diameter of approximately seventy miles.

20. The method as set forth in claim 1 wherein the limited period of time is less than one month.

21. The method as set forth in claim 20 wherein the limited period of time is approximately three weeks.

22. The method as set forth in claim 1 wherein the products of the group are selected from predetermined furniture and bedding products.

23. The method as set forth in claim 22 wherein the products of the group include bedroom groups and matching case goods.

24. The method as set forth in claim 23 wherein the products of the group include two different bedroom groups.

25. The method as set forth in claim 22 wherein the products of the group include specialty sleep mattresses.

26. The method as set forth in claim 22 wherein the products of the group include at least one product selected from latex pillows, memory foam pillows, and massage systems.

27. The method as set forth in claim 1 wherein the second party sales people are paid on a straight commission basis and all advertising, fees and expenses associated with the method, except for warehousing and delivery costs and cost of the products, are borne by the chain and by the first party.

28. The method as set forth in claim 1 wherein the first party schedules the times during which the method will be performed with the chain.

29. The method as set forth in claim 1 wherein the first party generates UPC codes for the products of the group for use in the stores of the chain.

30. The method as set forth in claim 1 wherein the first party provides inventory control services for the second party with respect to the products of the group being sold in said store of the chain.

31. The method as set forth in claim 1 wherein the second party provides post-sale service with respect to product purchased by said members in the vicinity.

32. The method as set forth in claim 1 wherein the second party has a showroom, said products of the group also being displayed in said showroom at the same time as said products are displayed at said store of the chain.

33. The method as set forth in claim 1 wherein said products are sold at listed prices in said store.

34. The method as set forth in claim 1 wherein the second party sales people are paid on a strict commission basis, said commission exceeding a commission paid by the second party to sales people at second party facilities.

35. The method as set forth in claim 1 wherein the second party at least participates in the selection of the products constituting the group.

36. The method as set forth in claim 35 wherein the method is also performed in connection with a second store of the chain, said second store being in a different geographic region from the first store, a third party doing business in the vicinity of the second store replacing the second party in the method, said third party at least participating in the selection of the products constituting the group for the second store, the group of products for the second store being not necessarily the same as the group of products for the first store.

37. The method as set forth in claim 36 wherein the third party at least participates in the pricing of the products offered in the second store.

38. The method as set forth in claim 35 wherein the second party at least participates in the pricing of the products offered in the first store.

39. The method as set forth in claim 1 wherein the first party ships at least some products of the group directly from the manufacturer to the second party.

40. The method as set forth in claim 39 wherein at least some products of the group are shipped to the second party in container lots.

41. The method as set forth in claim 40 wherein the first party has warehouse facilities and, in the event of delay in container lot shipments, ships product directly to the second party from said first party warehouse facilities.

42. The method as set forth in claim 41 wherein the first party provides product in the event of said delay in container lot shipments at a price corresponding to a container lot price.

43. The method as set forth in claim 1 wherein the payment is also divided with the first party.
